(19) United States
(12) Patent Application Publication
(10) Pub. No.: US 2013/0092653 A1
(43) Pub. Date: Apr. 18, 2013

(54) Electrode Forming Method

(71) Applicants: Jae Il Kim, Gyunggi-do (KR); Jong Young Lee, Gyunggi-do (KR); Sang Hwa Kim, Gyunggi-do (KR)

(72) Inventors: Jae Il Kim, Gyunggi-do (KR); Jong Young Lee, Gyunggi-do (KR); Sang Hwa Kim, Gyunggi-do (KR)

(73) Assignee: SAMSUNG ELECTRO-MECHANICS CO., LTD., Gyunggi-do (KR)

(21) Appl. No.: 13/333,538

(22) Filed: Dec. 21, 2011

(30) Foreign Application Priority Data
Oct. 12, 2011 (KR) 1020110104194

(51) Int. Cl. H01B 13/00; B32B 38/10

(52) U.S. Cl. 216/20; 156/247; 156/60; 216/13

(57) ABSTRACT

Disclosed herein is an electrode forming method including: an electrode layer forming process of forming a conductive transparent electrode layer by stacking a metal oxide on a transparent substrate; and an electrode pattern forming process of forming patterned electrodes by selectively applying a coating liquid including an oxidizing agent to the conductive transparent electrode layer and electrically inactivating the conductive transparent electrode layer.

### CROSS REFERENCE TO RELATED APPLICATION

This application claims the benefit of Korean Patent Application No. 10-2011-0104194, filed on Oct. 12, 2011, entitled “Electrode Forming Method”, which is hereby incorporated by reference in its entirety into this application.

### BACKGROUND OF THE INVENTION

1. Technical Field

The present invention relates to an electrode forming method.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, a capacitive type touch panel and a digital resistive type touch panel in which multi-touch may be performed have been prominent.

However, since a transparent electrode in the capacitive type touch panel according to the prior art has a unique color, when patterning is performed, a shape of the transparent electrode is recognized by users. For example, in the case in which the transparent electrode is patterned in a bar shape, the user recognizes the bar shape, and in the case in which the transparent is patterned in a rhombus shape, the user recognizes the rhombus shape. Therefore, the patterned transparent electrode in the touch panel according to the prior art impedes an image output from an image display device and deteriorates the entire visibility.

In addition, the transparent electrode of the capacitive type touch panel according to the prior art is formed by selectively removing and patterning a transparent electrode layer. However, the transparent electrode is damaged during a process of removing a conductive transparent electrode layer, such that a physical defect is generated.

### SUMMARY OF THE INVENTION

The present invention has been made an effort to provide an electrode forming method forming an electrode without physically damaging the electrode.

The present invention has been made an effort to provide an electrode forming method removing a color difference between an electrode and a non-electrode part.

According to a preferred embodiment of the present invention, there is provided an electrode forming method including: an electrode layer forming process of forming a conductive transparent electrode layer on a transparent substrate; and an electrode pattern forming process of forming patterned electrodes by selectively applying a coating liquid including an oxidizing agent to the conductive transparent electrode layer and electrically inactivating the conductive transparent electrode layer.

The oxidizing agent may be any one of sodium hypochlorite (NaOCl), potassium permanganate (KMnO₄), potassium dichromate (K₂Cr₂O₇), and amine oxide.

The coating liquid may further include a dyeing agent.

The dyeing agent may comprise a prussian blue or a methylene blue.

The conductive transparent electrode layer may be made of a conductive polymer.

The electrode pattern forming process may further include a process of stacking a resist on the conductive transparent electrode layer, wherein the coating liquid is applied after stacking the resist.

The electrode forming method may further include a cleaning process of cleaning the coating liquid remaining on the conductive transparent electrode layer after the electrode pattern forming process.

According to another preferred embodiment of the present invention, there is provided an electrode forming method including: an electrode layer forming process of forming a conductive transparent electrode layer on a transparent substrate; and an electrode pattern forming process of forming patterned electrodes by selectively adhering an electrical inactive tape to the conductive transparent electrode layer and electrically inactivating the conductive transparent.

The electrical inactive tape may include an adhesion part formed on one surface thereof, and the adhesion part may include an adhesive and an oxidizing agent.

The oxidizing agent may be any one of sodium hypochlorite (NaOCl), potassium permanganate (KMnO₄), potassium dichromate (K₂Cr₂O₇), and amine oxide.

The adhesion part may further include a dyeing agent.

The dyeing agent may comprise a prussian blue or a methylene blue.

The conductive transparent electrode layer may be made of a conductive polymer.

The electrode forming method may further include a foreign material removing process of removing the electrical inactive tape attached to the conductive transparent electrode layer after the electrode pattern forming process.

### BRIEF DESCRIPTION OF THE DRAWINGS

FIG. 1 is a flow chart of an electrode forming method according to a preferred embodiment of the present invention;

FIGS. 2 to 4 are cross-sectional views showing the electrode forming method according to the preferred embodiment of the present invention in a process sequence;

FIG. 5 is a flow chart of an electrode forming method according to another preferred embodiment of the present invention; and

FIGS. 6 and 7 are cross-sectional views showing the electrode forming method according to another preferred embodiment of the present invention in a process sequence.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the present invention may be modified in various different ways and is not limited to the embodiments provided in the present description. Further, in describing the present invention, a detailed description of related known functions or configurations will be omitted so as not to obscure the subject of the present invention.

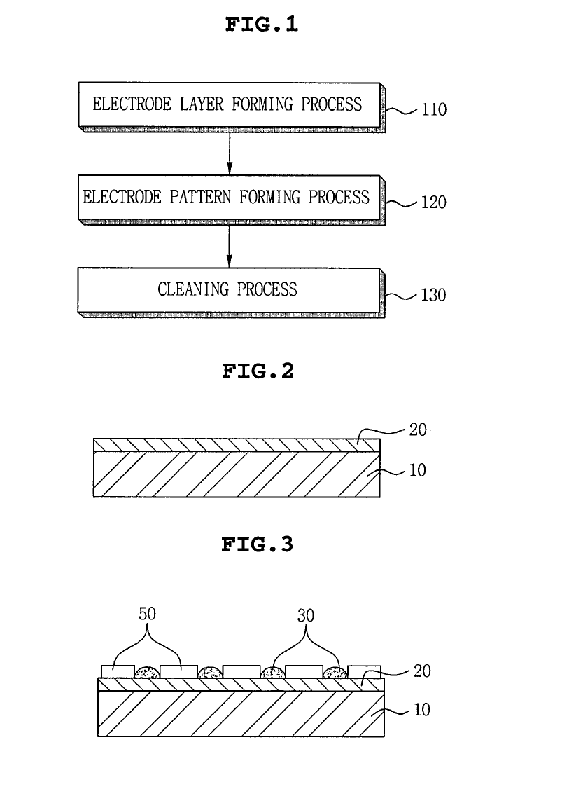

FIG. 1 is a flow chart of an electrode forming method according to a preferred embodiment of the present invention; and FIGS. 2 to 4 are cross-sectional views showing the electrode forming method according to the preferred embodiment of the present invention in a process sequence.

Referring to FIG. 1, the electrode forming method according to a preferred embodiment of the present invention includes an electrode layer forming process and an electrode pattern forming process, such that electrodes 21 are formed on one surface or both surfaces of a transparent substrate 10. In addition the electrode forming method may further include a cleaning process removing an unnecessary residual material after the electrode pattern forming process.

Hereinafter, the electrode forming method according to the preferred embodiment of the present invention will be described in more detail with reference to FIGS. 1 to 4.

### PREFERRED EMBODIMENT

Referring to FIG. 2, in the electrode layer forming process, a conductive transparent electrode layer 20 is formed on one surface or both surfaces of the transparent substrate 10 by stacking a conductive polymer on the transparent substrate 10 (110).

Here, the conductive transparent electrode layer 20 may be formed by stacking the conductive polymer on the transparent substrate 10 through screen printing. However, the conductive transparent electrode layer is not limited to being formed by the screen printing but may be formed by, for example, gravure printing, offset printing, inkjet printing, or the like.

In addition, the conductive polymer includes poly-3,4-ethylenedioxythiophene/polystyrenesulfonate (hereinafter, referred to as PEDOT/PSS), polyaniline, polyacetylene, polyphenylenevinylene, or the like. Here, the conductive polymer may further include a liquid crystal polymer, such that the conductive polymer may be made of a conductive polymer composition in which the conductive polymer and the liquid crystal polymer are mixed with each other.

Here, the liquid crystal polymer is a compound showing both of liquid crystal characteristics and polymer characteristics. In addition, the liquid crystal, which is an intermediate state between solid and liquid, does not have a positional order unlike the solid but have an orientational order, thereby showing a unique property, and shows a property different from the liquid that does not have any order.

As described above, since the liquid crystal polymer retains a unique orientational order of the liquid crystal as it is, in the case in which the liquid crystal polymer is mixed with the conductive polymer composition and is coated, it has an influence on a shape and an arrangement of the conductive polymer. Therefore, due to a high order of the liquid crystal polymer, an order of the conductive polymer may also be increased, and the conductivity of a film made of conductive polymer composition may be significantly increased.

In addition, the conductive polymer composition may further include a dispersion stabilizer. As the dispersion stabilizer, ethylene glycol, sorbitol, or the like, may be used.

Furthermore, a binder, a surfactant, a defoamer, or the like, may also be added to the conductive polymer composition.

Meanwhile, the transparent substrate 10 may be made of polyethylene terephthalate (PET), polyethylene naphthalate (PEN), polyethersulpon (PES), glass, or tempered glass, polycarbonate (PC), cyclic olefin polymer (COC), poly methyl methacrylate (PMMA), triacetylcellulose (TAC), biaxially stretched polystyrene (BOPS: containing K resin), or a mixture thereof, and a transparent film in which they are stacked.

In addition, in a capacitive type structure, a transparent film is made of a material having high permittivity. Here, in the case in which the transparent film has high permittivity, capacitance is increased, such that sensibility becomes excellent.

Therefore, the transparent film may be any one selected from a group consisting of polyethylene terephthalate (PET) having permittivity of 2.9 to 3.5, glass having permittivity of 7.5 to 8, a silicon based film having permittivity of 2.5 to 7, an urethane based film having permittivity of 6.5 to 7, poly methyl methacrylate (PMMA) having permittivity of 2.5 to 4.5, and polycarbonate (PC) having permittivity of 2.5 to 3.5.

Referring to FIG. 3, in the electrode pattern forming process, a coating liquid 30 including an oxidizing agent and a dyeing agent is selectively applied on one side portion of the conductive transparent electrode layer 20 formed through the electrode layer forming process.

Then, referring to FIG. 4, when a predetermined time elapses after the coating liquid 30 is applied to one side portion of the conductive transparent electrode layer 20, the oxidizing agent included in the coating liquid 30 permeates into one side portion of the conductive transparent electrode layer 20, such the one side portion of the conductive transparent electrode layer 20 is electrically inactivated by the oxidizing agent to form non-electrode parts 22. Therefore, patterns are selectively formed on the other side portion of the conductive transparent electrode layer 20 except for one side portion thereof, such that the electrodes 21 may be formed (120).

Here, the oxidizing agent may be any one of sodium hypochlorite (NaOCl), potassium permanganate (KMnO₄), potassium dichromate (K₂Cr₂O₇), and amine oxide. However, the oxidizing agent of the present invention is not limited thereto.

Meanwhile, in the case in which the conductive transparent electrode layer 20 is formed using PEDOT/PSS, the conductive transparent electrode layer 20 represents a blue color. However, a color of the non-electrode part 22 formed on one side portion of the conductive transparent electrode layer 20 by the oxidizing agent included in the coating liquid 30 are changed into an orange color, such that a color different occurs between the non-electrode part 22 and the electrode 21 formed on the other side portion of the conductive transparent electrode layer 20 representing the blue color.

Here, when the dyeing agent is included in the coating liquid 30 and is selectively applied together with the oxidizing agent to the conductive transparent electrode layer 20, one side portion of the conductive transparent electrode layer 20 changed into the orange color by the oxidizing agent is dyed with a blue color, such that a color different is removed and visibility is improved.

Here, the dyeing agent may comprise a prussian blue or a methylene blue. However, the dyeing agent according to the preferred embodiment of the present invention is not limited thereto.

In addition, at the time of application of the coating liquid 30 to one side portion of the conductive transparent electrode layer 20, an electrical inactivating process and a dyeing process of one side portion of the conductive transparent electrode layer 20 may be simultaneously performed.

Further, the coating liquid 30 may be made of a paste including, for example, an oxidizing agent, a dyeing agent, and glycerin. However, the coating liquid 30 according to the preferred embodiment of the present invention is not limited thereto.

In addition, the coating liquid 30 may be made of a paste including, for example, an oxidizing agent (0.1 to 10 wt %), a dyeing agent (0.1×10⁻⁸ to 1 wt %), and glycerin (a remaining content except for content ratios of the oxidizing agent and the dyeing agent based on 100 wt %). However, the coating liquid 30 according to the preferred embodiment of the present invention is not limited thereto.

Meanwhile, the electrode pattern forming process further includes a process of stacking a resist 50 on the conductive transparent electrode layer 20, wherein the coating liquid is applied after the resist is stacked.

Here, at the time of the application of the coating liquid 30 including the oxidizing agent to the conductive transparent electrode layer 20, the resist 50 is stacked on the other side portion of the conductive transparent electrode layer 20, and the coating liquid 30 is applied to one side portion of the conductive transparent electrode layer 20 to electrically inactivate only portions at which the resist 50 is positioned, thereby making it possible to form the electrode pattern.

In addition, an electrode wiring receiving an electrical signal from the electrode 21 is printed on an edge of the electrode 21. Here, as a material of the electrode wiring, a material including silver (Ag) paste or organic silver that have excellent electrical conductivity may be used. However, the material of the electrode wiring is not limited thereto but may be a metal oxide such as a conductive polymer, a carbonblack (including CNT), an ITO, or a low resistance metal such as metals, or the like.

Meanwhile, the electrode pattern forming process according to the preferred embodiment of the present invention further includes a heat treatment process, thereby making it possible to easily form the electrode 21 of the conductive transparent electrode layer 20.

In the heat treatment process, the coating liquid 30 including the oxidizing agent and the dyeing agent is applied to the conductive transparent electrode layer 20 of the transparent substrate 10 and is then subjected to heat treatment at a temperature of 50 to 150° C. for 5 to 60 minutes, thereby making it possible to easily form the electrode 21 of the conductive transparent electrode layer 20 and improve visibility. However, the temperature and time of the heat treatment process according to the preferred embodiment of the present invention are not necessarily limited thereto.

Referring to FIG. 1, in the cleaning process, the conductive transparent electrode layer 20 is cleaned using a cleaning liquid, such that the coating liquid 30 remaining on an outer surface of the conductive transparent electrode layer 20 is removed. Here, the cleaning liquid is distilled water. However, the cleaning liquid used in the cleaning process of the present invention is not limited thereto (130).

In addition, a predetermined time elapses after the transparent substrate 10 in which the conductive transparent electrode layer 20 is formed is immersed into a tank or a container filled with the distilled water, the coating liquid 30 remaining on the outer surface of the conductive transparent electrode layer 20 is removed, and the transparent substrate 10 is then taken out from the tank or the container, whereby a cleaning process ends.

However, the cleaning method of the transparent substrate 10 of the present invention is not limited thereto. For example, the coating liquid 30 remaining on the conductive transparent electrode layer 20 may be removed by spraying the distilled water on the conductive transparent electrode layer 20 or positioning the transparent substrate 10 including the conductive transparent electrode layer 20 in flowing distilled water.

Therefore, the electrode 21 is formed on the transparent substrate 10 by the electrode forming method according to the preferred embodiment of the present invention as described above, such that the electrode 21 may be formed without physically damaging a shape of the conductive transparent electrode layer 20.

Therefore, a step is not formed between the electrode 21 and the non-electrode part 22, such that a transparent film, a transparent glass, or the like, may be easily adhered and visibility may be improved.

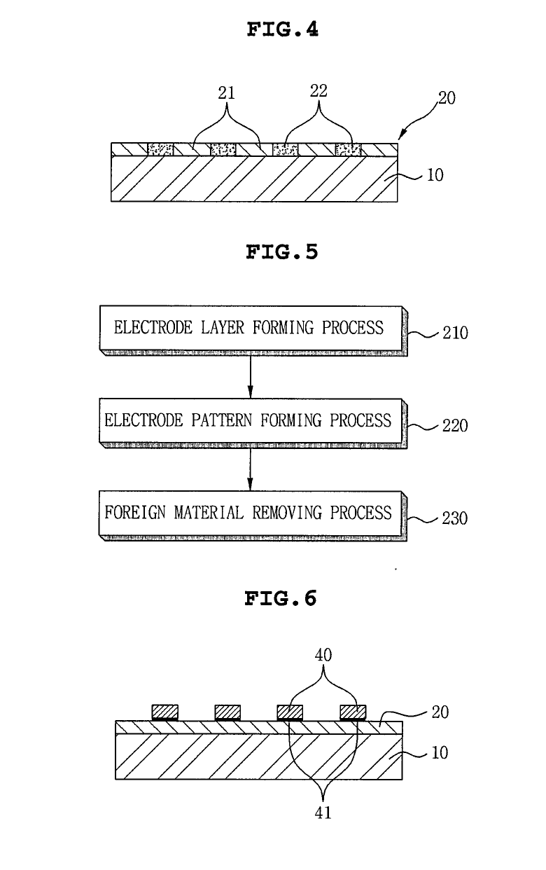

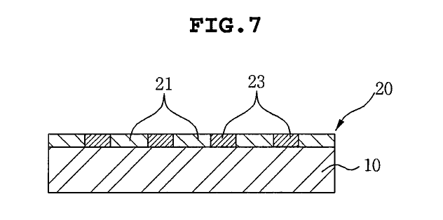

FIG. 5 is a flow chart of an electrode forming method according to another preferred embodiment of the present invention; and FIGS. 6 and 7 are cross-sectional views showing the electrode forming method according to another preferred embodiment of the present invention in a process sequence.

Hereinafter, the electrode forming method according to another preferred embodiment of the present invention will be described in more detail with reference to FIGS. 5 to 7.

In describing the electrode forming method according to another preferred embodiment of the present invention, a detailed description of the same configuration as the configuration according to the preferred embodiment of the present invention shown in FIGS. 1 to 4 will be omitted, and a configuration different from the configuration according to the preferred embodiment of the present invention shown in FIGS. 1 to 4 will be described.

Referring to FIG. 5, the electrode forming method according to another preferred embodiment of the present invention includes an electrode layer forming process and an electrode pattern forming process. In addition, the electrode forming method according to another preferred embodiment of the present invention may further include a foreign material removing process removing an electrical inactive tape 40 adhered to the conductive transparent electrode layer 20 after the electrode pattern forming process is finished.

### ANOTHER PREFERRED EMBODIMENT

In the electrode layer forming process, which is a process of forming a conductive transparent electrode layer 20 on a transparent substrate 10, the conductive transparent electrode layer 20 is formed by stacking a conductive polymer such as poly-3,4-ethylenedioxythiophene (PEDOT), or the like (210).

Referring to FIGS. 6 and 7, in the electrode pattern forming process, the electrode pattern is formed by selectively adhering an electrical inactive tape 40 on one side portion of the conductive transparent electrode layer 20 (220).

Here, the electrical inactive tape 40 includes an adhesion part 41 formed on one surface thereof, such that it is adhered to one side portion of the conductive transparent electrode layer 20 through the adhesion part 41. Here, the adhesion part 41 is configured to include an adhesive and an oxidizing agent.

In addition, when the adhesion part 41 of the electrical inactive tape 40 is adhered to one side portion of the conductive transparent electrode layer 20, the oxidizing agent included in the adhesion part 41 reacts to the conductive transparent electrode layer 20, such that one side portion of the conductive transparent electrode layer 20 is electrically inactivated to form a non-electrode part 23.

Therefore, patterns of an electrical active area are formed on the other side portion of the conductive transparent electrode layer 20, such that the electrodes 21 are formed.

Here, the adhesive may be polyacrylate, and the oxidizing agent may be any one of sodium hypochlorite (NaOCl), potassium permanganate (KMnO₄), potassium dichromate (K₂Cr₂O₇), any amine oxide. However, the adhesive and the oxidizing agent of the present invention are not limited thereto.

In addition, the adhesion part 41 further includes a dyeing agent, thereby making it possible to dye one side portion of the conductive transparent electrode layer 20 color-changed by the oxidizing agent so as to represent the same color as that of the other side portion of the conductive transparent electrode layer 20. Here, the dyeing agent may comprise a prussian blue or a methylene blue. However, the dyeing agent according to the preferred embodiment of the present invention is not limited thereto.

Meanwhile, the electrode pattern forming process according to another preferred embodiment of the present invention further includes a heat treatment process, thereby making it possible to easily form the electrode patterns of the conductive transparent electrode layer 20.

In the heat treatment process, the oxidizing agent is applied to the conductive transparent electrode layer 20 of the transparent substrate 10 and is then subjected to heat treatment at a temperature of 50 to 150° C. for 5 to 60 minutes, thereby making it possible to easily form the electrode patterns of the conductive transparent electrode layer 20. However, the temperature and time of the heat treatment process according to another preferred embodiment of the present invention are not necessarily limited thereto.

Referring to FIG. 7, in the foreign material removing process, the electrical inactive tape 40 adhered to one side portion of the conductive transparent electrode layer 20 is removed. Here, after the foreign material removing process, a separate cleaning process is not required, such that a work time may be reduced (230).

Therefore, at the time of forming of the electrode 21 by the electrode forming method according to another preferred embodiment of the present invention as described above, the electrode 21 may be formed without physically damaging a shape of the conductive transparent electrode layer 20.

Therefore, a step is not formed between the electrode 21 and the non-electrode part 23, such that a transparent film, a transparent glass, or the like, may be easily adhered and visibility may be improved.

According to the preferred embodiments of the present invention, the electrode is formed using the oxidizing agent without being physically damaged, such that the step between the electrode and the non-electrode part is not formed, thereby making it possible to improve visibility.

In addition, according to the preferred embodiments of the present invention, the color difference between the electrode and the non-electrode part is removed using the dyeing agent, thereby making it possible to improve the visibility.

Although the embodiment of the present invention has been disclosed for illustrative purposes, it will be appreciated that an electrode forming method according to the invention is not limited thereby, and those skilled in the art will appreciate that various modifications, additions and substitutions are possible, without departing from the scope and spirit of the invention.

In addition, any and all modifications, variations or equivalent arrangements should be considered to be within the scope of the invention, and the detailed scope of the invention will be disclosed by the accompanying claims.

What is claimed is:

1. An electrode forming method comprising:
an electrode layer forming process of forming a conductive transparent electrode layer on a transparent substrate; and
an electrode pattern forming process of forming patterned electrodes by selectively applying a coating liquid including an oxidizing agent to the conductive transparent electrode layer and electrically inactivating the conductive transparent electrode layer.

2. The electrode forming method as set forth in claim 1, wherein the oxidizing agent is any one of sodium hypochlorite (NaOCl), potassium permanganate (KMnO₄), potassium dichromate (K₂Cr₂O₇), and amine oxide.

3. The electrode forming method as set forth in claim 1, wherein the coating liquid further includes a dyeing agent.

4. The electrode forming method as set forth in claim 3, wherein the dyeing agent comprises a prussian blue or a methylene blue.

5. The electrode forming method as set forth in claim 1, wherein the conductive transparent electrode layer is made of a conductive polymer.

6. The electrode forming method as set forth in claim 1, wherein the electrode pattern forming process further includes a process of stacking a resist on the conductive transparent electrode layer,
the coating liquid being applied after stacking the resist.

7. The electrode forming method as set forth in claim 1, further comprising a cleaning process of cleaning the coating liquid remaining on the conductive transparent electrode layer after the electrode pattern forming process.

8. An electrode forming method comprising:
an electrode layer forming process of forming a conductive transparent electrode layer on a transparent substrate; and
an electrode pattern forming process of forming patterned electrodes by selectively adhering an electrical inactive tape to the conductive transparent electrode layer and electrically inactivating the conductive transparent electrode layer.

9. The electrode forming method as set forth in claim 8, wherein the electrical inactive tape includes an adhesion part formed on one surface thereof, and
the adhesion part includes an adhesive and an oxidizing agent.

10. The electrode forming method as set forth in claim 8, wherein the oxidizing agent is any one of sodium hypochlorite (NaOCl), potassium permanganate (KMnO₄), potassium dichromate (K₂Cr₂O₇), and amine oxide.

11. The electrode forming method as set forth in claim 9, wherein the adhesion part further includes a dyeing agent.

12. The electrode forming method as set forth in claim 11, wherein the dyeing agent comprises a prussian blue or a methylene blue.

13. The electrode forming method as set forth in claim 8, wherein the conductive transparent electrode layer is made of a conductive polymer.

14. The electrode forming method as set forth in claim 8, further comprising a foreign material removing process of removing the electrical inactive tape attached to the conductive transparent electrode layer after the electrode pattern forming process.
